(19) United States
(12) Patent Application Publication
(10) Pub. No.: US 2024/0033679 A1
(43) Pub. Date: Feb. 1, 2024

(54) Multiscale architectures for reducing regeneration energy of solvents in CO2 capture

(71) Applicant: BATTELLE MEMORIAL INSTITUTE, Columbus, OH (US)

(72) Inventors: Amy M. Heintz, Dublin, OH (US); Krenar Shqau, Columbus, OH (US)

(21) Appl. No.: 18/226,753

(22) Filed: Jul. 26, 2023

Related U.S. Application Data
(60) Provisional application No. 63/392,230, filed on Jul. 26, 2022.

(51) Int. Cl. B01D 53/14; B01D 53/18

(52) U.S. Cl. CPC B01D 53/1475; B01D 53/18; B01D 2257/504; B01D 2252/204

(57) ABSTRACT

A method of desorbing CO₂ from a CO₂-containing liquid solvent, comprising: providing a liquid solution comprising CO₂; contacting the liquid to a porous anodized aluminum surface or porous anodized titanium surface while increasing the temperature or reducing the pressure of the liquid solution; and separating desorbed CO₂ gas from the liquid solution. A desorption composition is provided comprising: an anodized aluminum substrate coated with a porous alumina layer and a functionalized surface and characterizable by an infrared absorption near 1712 cm⁻¹ and a Raman band near 530 cm⁻¹.

### RELATED APPLICATIONS

This application claims the priority benefit of U.S. Provisional Patent Application Ser. No. 63/392,230, filed 26 Jul. 2022, incorporated herein by reference.

### INTRODUCTION

One of the major sources of CO₂ comes from “low purity” CO₂ streams such as cement and steelmaking. The current process for capture and storage at these sites involves CO₂ capture, using an absorbing column containing amine, desorption of CO₂ and regeneration of the amine, CO₂ compression, CO₂ transport and then storage.

Amine solvents, usually mixed with water, are used for capturing CO₂ from sources such as industrial plants and natural gas. The capture process often involves passing the feed through a packed column or tray. After capture, the process is reversed, sending the CO₂-rich absorbent to a desorber where the temperature is usually raised from 40° C. to 120° C.—this provides a pure CO₂ stream that can be compressed and stored and regenerates the amine. This process is highly energy consumptive, and the heat cycling of the amine limits the lifetime of the scrubber and can generate harmful amine vapors.

A variety of methods are used to desorb CO₂ from capture liquids such as amines. The first step can involve chemical reactions to decompose carbamates and other forms of reacted CO₂ back to CO₂; then this CO₂ must be removed from the solution, which involves some level of thermal evaporation. Cavitation is the process of forming a vapor phase by using reduced pressure. The reduced pressure can be achieved with a vacuum, though, it can also be achieved by controlling the fluid flow, per Bernoulli's theorem.

According to Bernoulli's theorem, the velocity of a fluid and the pressure drops as it passes through a constriction, assuming the flow rate is maintained. If this pressure drop is sufficient, it can cause the CO₂ to desorb. However, while this is an effective way to desorb CO₂, it requires extremely high back pressure to achieve the necessary velocity to achieve CO₂ desorption.

### SUMMARY OF THE INVENTION

We have found that a multi-scale-structured material applied to a random packing media or tray surface reduces the temperature required to desorb CO₂ and does not require high and/or low operating pressures requiring special equipment. In addition, we have identified novel flow geometries performed using flex-ring random packing that works together with these structures to reduce pressure and temperature.

In a first aspect, the invention provides a method of desorbing CO₂ from a CO₂-containing liquid solvent, comprising: providing a liquid solution comprising CO₂ at a first temperature and first pressure; wherein the liquid solution comprises at least 10 mass % of one or more amines; contacting the liquid to a porous anodized aluminum surface or porous anodized titanium surface while increasing the temperature or reducing the pressure of the liquid solution; and simultaneously or subsequently, separating desorbed CO₂ gas from the liquid solution. Porous anodized surfaces can be identified by their characteristic ordered pitted surface.

Any aspects of the invention can be further characterized by one or any combination of the following features: wherein the one or more amines comprise one or more amines selected from: secondary amines, tertiary amines, and hindered primary amines; wherein the porous anodized aluminum surface or porous anodized titanium surface has a water contact angle of 12° or less, or 5° or less, or in the range of 1° to 10°; wherein the porous anodized aluminum surface or porous anodized titanium surface has a pore structure such that at least 80 vol % of the pores are between 20 to 150 nm, or between 40 to 100 nm, or between 20 and 50 nm; wherein the surface comprises cracks or microscale pathways (these are typical of anodized surfaces); wherein the cracks or microscale pathways comprise depths of at least 1.5 μm and/or depths up to 20 μm; wherein the porous anodized aluminum surface or porous anodized titanium surface has a thickness of at least about 10 μm into an aluminum or titanium substrate; the thickness can be characterized by the term “about” because the transition from metal to oxide may be gradual and this may be observed in cross-section and a skilled worker can determine with reasonable certainty whether the thickness is “about” of at least about 10 μm; wherein the step of contacting occurs in a column with the porous anodized aluminum surface or porous anodized titanium surface is disposed over a plurality of plates; wherein the porous anodized aluminum surface or porous anodized titanium surface is disposed on the surface of a packing material; wherein the step of contacting the liquid to a porous anodized aluminum surface or porous anodized titanium surface occurs while increasing the temperature by at least 10° C., or at least 20° C., or at least while the amine remains a liquid; wherein the step of contacting occurs at an angle in the range of 30 to 60° or 40 to 50°; wherein at least 30% or at least 50% or at least 70%, or in the range of 70 to 90% of CO2 in the CO2-containing liquid solvent is removed in the step of separating desorbed CO2 gas from the liquid solution; wherein the step of contacting the liquid comprises a jet of the liquid contacting the surface at a velocity of at least 10 m/s or at least 30 m/s or 25 to 200 m/s or 10 to 100 m/s; wherein the contacting step is conducted at a temperature of 60 to 90° C. and wherein at least 30% or at least 50% or at least 80% or 50 to about 90% of the CO2 is desorbed.

In any of the inventive aspects, the liquid solvent may comprise one or any combination of: 2-amino-2-methyl-1-propanol (AMP), monoethanolamine (MEA), 4-hydroxy-1-methylpiperidine (HMPD), dimethylaminoethoxyethanol (DMAEE), methylaminoethoxyethanol (MAEE), Aminoethoxyethanol (Diglycolamine) (DGA), diisopropanolamine (DIPA), diethanolamine (DEA), piperazine, imidazoles, cyclic and long-chain diamines, and ether amines; in some aspects, the liquid comprises at least 50%, at least 70%, or at least 90% (mass %) of one or more amines; typically in the presence of water.

In a second aspect, the invention provides a desorption composition comprising: an anodized aluminum substrate, coated with a porous alumina layer and a functionalized surface having an infrared absorption near 1712 cm⁻¹; and a Raman band near 530 cm⁻¹ when excited using 633 nm excitation. The desorption composition can be utilized in a method of desorbing CO₂ from a CO₂-containing liquid solvent.

Any aspects of the invention can be further characterized by one or any combination of the following features: wherein the functionalized surface of the desorption composition has a fluffy appearance when viewed under a microscope; the desorption composition having surface pores having a diameter in the range of 20-150 nm or 40-100 nm wherein these pores make up at least 80 vol % of the porosity; the desorption composition wherein the functionalized layer comprises a thickness in the range of 5 to 25 μm; the desorption composition wherein the functionalized surface comprises ester groups; the desorption composition wherein the functionalized surface comprises the reaction product of a aluminum hydroxide with a carboxylic acid; preferably oxalic acid; the desorption composition wherein the functionalized surface has a needle appearance when viewed under a scanning electron microscope; wherein the functionalized surface has a contact angle of 10° or less, 5° or less, 1 to 5°; wherein the functionalized surface has a Ra of 1 to 5 μm or less; 1 to 3 μm; or 2 to 3 μm; and/or wherein the functionalized surface has a Rz of 10-30 μm; or 15 to 25 μm. The composition may be in the form of plates, ring shape or fibrous packing media materials. The invention also includes desorption apparatus or components wherein the functionalized surface is applied to packing materials, or to regenerator tray designs.

The composition may be further characterized by the test conditions of the examples and exhibiting ±30% or ±20% or ±10% of the desorption in the examples.

The invention also may include systems comprising a combination of conditions and compositions including a desorption surface, preferably the desorption composition defined above. The system may be further characterized by features such as apparatus, liquid composition, flow rate, and temperature.

### BRIEF DESCRIPTION OF THE DRAWINGS

FIG. 1: FTIR spectra reveal the presence of 1700cm⁻¹ peak associated with aluminum hydroxide esters at preferred surface (1xxx), and at a much less effective surface (3xxx) as well as the absence of 1700 cm⁻¹ peak for an ineffective surface (6xxx) prepared by anodization using oxalic acid as the anodization bath.

FIG. 2: Scanning Electron Microscopy (SEM) of surfaces morphology for a preferred surface (1xxx) with high surface porosity, a much less effective surface (3xxx) with relatively high porosity and an ineffective surface (6xxx) with relatively low porosity prepared by anodization using oxalic acid as the anodization bath.

FIG. 3: top 3D Laser scanning microscopy (LSM, obtained by Keyence Model VK-X260K) of surfaces, profilometry. The thickness of Functional layer characterized for preferred surface (1xxx), a much less effective surface (3xxx) and an ineffective surface (6xxx) are 25 μm, 10 μm and 3.9 μm, respectively. Bottom—optical microphotographs.

FIG. 4 schematically illustrates a system for regenerating amine and removing/capturing CO₂.

FIG. 5 shows Raman spectra for anodized aluminum.

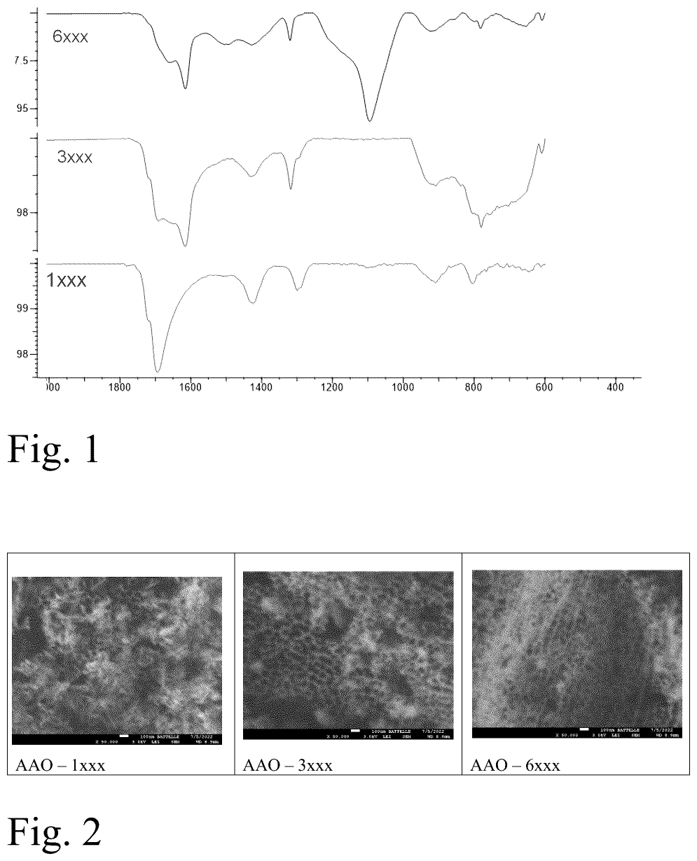

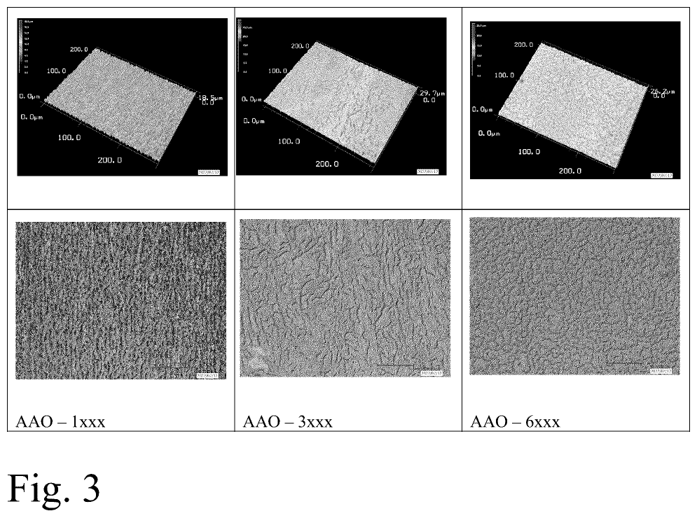

### DETAILED DESCRIPTION OF THE INVENTION

The invention includes a high surface energy, multi-scale structured coating that, when applied to packing media or trays used for liquid CO₂ capture processes, reduces the energy required to desorb the CO₂. The structure is comprised of a high surface energy material, such as appropriately-formed anodized aluminum, which has functionalized aluminum hydroxide surface composition characterized by an infrared spectral signature with a peak near 1712 cm−1 and a Raman spectral signature achieved with a peak near 530 cm−1 obtained using 633 nm excitation, providing a surface energy higher than 150 dyn-cm and sufficient hydrophilicity to allow complete wetting of the amine solution. The contact angles with water are preferably lower than 12° and more preferably lower than 5°. The structure has a high density of nanoscale pits and a microstructured fluffy layer comprised of needle shape, functionalized Al hydroxides on the surface. Anodization of aluminum under the conditions described here can generate such structures. Pit diameter between 20 nm to 150 nm is effective. or 40-100, and preferably highly uniform such that at least 80% (by vol) of the pores have maximum diameters within a range of 50 nm or within 20 nm. Finally, the structure contains microscale pathways into the depths of the coating. Analysis of surfaces by scanning electron microscopy and/or laser scanning microscopy will reveal microscale pathways with arithmetic mean roughness of approximately 1.5 to 3 μm, with depths up to 10-20 μm into the sample. The surfaces are preferably anodized aluminum (having a characteristic pitted structure) or anodized titanium.

A method to produce these structures is by anodization of aluminum. For example, by anodization of aluminum trays and/or random packing media. As an example, aluminum random packing media can be purchased from Koch Glitsch. The media are loaded into an anodization basket, ensuring connectivity of all parts, and anodized in solutions such as phosphoric acid, oxalic acid and or sulfuric acid.

When anodized according to one of the preferred conditions for this invention, the aluminum surface becomes anodized first to aluminum oxide and then to needle shaped aluminum hydroxide and other functionalized aluminum hydroxide structures on the surface. Such a material is comprised of nanoscale pits on which exists larger domains of fluffy microscale material; there exists microscale voids/cracks between these domains, which provide access into the pitted structure. It further has a layer that appears “fluffy” under high magnification and under higher magnification is shown to have a needle-shape, which has certain spectroscopic properties. These features make the surface superhydrophilic and the pits promote the desorption.

The structures are different than what is formed by standard anodization procedures known in the art, such as found in membrane filters and protective coatings. Notably, our surfaces contain two vibrational spectral signatures that are characteristic and not found in anodized aluminum in the prior art. One is a Raman peak, obtained using 633 nm excitation, near 530 cm⁻¹. Another is in the infrared spectrum, which may be collected from these solid samples using attenuated total reflectance Fourier transform infrared spectroscopy (ATR FTIR), having an absorption peak near 1700 cm⁻¹. Wu et al (J. Colloid Interface Sci, 2015, 464) suggests that this peak may arise from an oxalic ester of Al(OH)3, which they obtained by high temperature reaction of Al(OH)3 powders, not from anodization. Without being bound to a theory, the chemistry may be important for achieving both high surface energy and reduced reactivity between the amine and the surface.

In addition, these materials have a unique multiscale structure. As shown by SEM, the surface morphology for a preferred surface (obtained using anodized aluminum 1xxx using oxalic acid as anodization bath) was different from other anodized coupons obtained from 6xxx and 3xxx type aluminum, which were not as effective for providing efficient desorption of CO₂. 1xxx aluminum is at least 99% pure Al; 3xxx is Al—Mn alloy; 6xxx is Al—Si alloy.

One way to achieve the inventive surface is by promoting fast anodization of aluminum. Without being bound to theory, it is believed that the formation of AlO(OH)/Al(OH)₃, Al₂O₃ is caused by the following multistep process:
fast formation of aluminum ion due to anodization process according to Al→Al³⁺+3 e-
[Al³⁺] increases onto Aluminum surface due to relatively slow diffusion process with respect to Al³⁺ formation and
The hydrolysis of proceeds according to the simple monomeric hydrolysis mechanism as Al³⁺+2H₂O→AlOH²⁺+H₃O⁺
The hydrolysis of Al³⁺ proceeds according to the simple monomeric hydrolysis mechanism as Al³⁺+2H₂O→AlOH²⁺+H₃O⁺
Esterification of resultant OH groups with oxalic acid bath

The multi-scale, hydrophilic structure works to lower the energy to desorb CO₂ from solution in several ways. The structure and surface energy of the coating promote wicking and acceleration of the CO₂-laden fluid when it flows over the surface. As fluid impinges onto the surface, wets, and flows across, there is a stagnation zone at the point of impact, and as the fluid wets the surface, its velocity increases, creating low pressure regions in the vena contracta and beyond. The low-pressure regions can facilitate desorption by cavitation. There are nucleating effects of the microscale and nanoscale features, which lower the energy required to desorb CO₂, similar to the effects of scratches on champagne glasses. The whiskers can promote a periodic pressure perturbation at relatively high frequency (in kHz range) according to the flow dynamic. Such a high frequency pressure perturbation originates because of its small dimension (˜10 to 25 nm) and the performance is significantly influenced, especially at nanoscale where a large surface area of the material is exposed.

The materials can have any macroscopic shape and are preferably in the form of plates, ring shape or fibrous packing media materials. The coating can be applied to packing materials, or to regenerator tray designs. When the modified packing media is used to replace non-structured media, the heat needed for desorption is lower.

Carbon dioxide is adsorbed into a liquid solvent, typically an amine, preferably an alkanol amine. Solvents for adsorbing and desorbing CO₂ include amines; primary, secondary, and tertiary amines and combinations thereof. Primary amines can be hindered or unhindered. An unhindered primary amine is an amine (RNH2) where R is a methyl group (CH₃) or R′CH₂—. Preferred examples of amine liquid solvents include: 2-amino-2-methyl-1-propanol (AMP), monoethanolamine (MEA), 4-hydroxy-1-methylpiperidine (HMPD), dimethylaminoethoxyethanol (DMAEE), methylaminoethoxyethanol (MAEE), Aminoethoxyethanol (Diglycolamine) (DGA), diisopropanolamine (DIPA), diethanolamine (DEA), piperazine, imidazoles, cyclic and long-chain diamines, and ether amines.

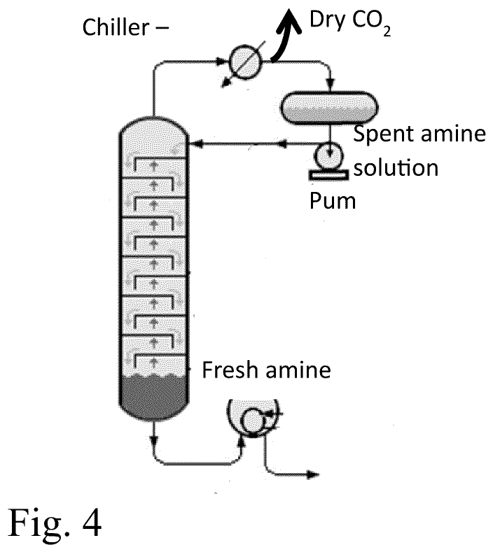

The manner in which the flow is achieved across the surfaces is also important to ensuring the pressure drops below the critical value required to promote cavitation. The performance can be further improved by creating new tray architectures and process flows that involve:
Creating stagnation zones as CO₂ containing fluid flows across the trays creating low pressure regions in the vena contracta and beyond; it is preferred that fluid is introduced as jets
a nano-structured surface at and/or beyond the stagnation zone to lower the energy to nucleation, allowing cavitation to occur at the low-pressure sites
   FIG. 4 shows a system for regenerating amine and removing/capturing CO₂. The CO₂-containing liquid is then passed to a regeneration unit where the CO₂ is desorbed, and the solvent can be reintroduced to the absorption unit. The figure shows a series of plates that are contacted by the CO₂-containing liquid. Pu=pump. An alternative to plates is a packing material.

Generally, the desorption of carbon dioxide from absorbent such as an amine solution is described according to Henry's law. Two main mechanisms are utilized to regenerate amine solvent
(i) temperature swing adsorption (TSA) widely used in industry operates at temperature above 100° C. (around 120° C.), and
(ii) pressure swing adsorption (PSA) below atmospheric pressure which is not industrially preferable.
   In the current invention, the desorption preferably takes place in contact with the multiscale-architecture surface that is described here. The overall process can include one or preferably a combination of the temperature swing adsorption (TSA) and pressure swing adsorption (PSA); for example, TSA desorption preferably in a range from 50 to 90° C., or 60 to 80° C., and/or localized pressure swing adsorption (PSA) desorption occurring around 5 psi (0.34 bar) or in the range up to 0.5 bar.

### EXAMPLES

Test setup:

For coupon screening, the CO₂ saturated amine fluid with specific gravity 1 g/cc and viscosity 100 cP was poured from height H (¾ to 1.5 inch) above AAO coupon. Fluid flows steadily down a surface incline θ (in degree) below the horizontal in anodized surface with pit size ranging 10 to 30 nm. The collision of the fluid with an activated solid surface (anodized surface) is affected by factors such as height and impact angle.

The residual CO₂ in amine fluid was measured with Chittik Apparatus.

The apparatus was comprised of a decomposition three—neck flask 150 mL connected to an acid dispensing separation funnel and a 10 cc pipette coupled with pressure monitoring U-shaped system via a connecting Tygon tubing. The gas evolved as a result of acid-base reaction pushes the water in pressure monitoring column. The volume of CO₂ was recorded from changes in water level in the pipette.

The number of moles of CO₂ present in amine solution can be calculated from the displaced CO₂ volume using the ideal gas equation:

$${n}_{{CO}_{2}} = \frac{PV}{RT}$$

where n is the numbers of mole of CO2 liberated from the reaction, P and V represents CO₂ partial pressure and displaced volume, respectively.

The tested coupons with constant size (2 in×2 in) and fixed incline angle at 45° were treated by pouring a stream at volume velocity varying from 15 to 25 cc/sec.

The shear stress acting on surface can generate the turbulence. The turbulence increases with the shear stress. Based on definition of the shear stress, the stress is given as

$$τ = ρ g ( X - y ) sin ( α + \frac{π}{2} ) \qquad eq . 1$$

Where: θ is surface incline angle (in degree)

$$θ = ( α + \frac{π}{2} )$$

According to the equations, the maximum value of the shear stress and the extension of stagnation point are achieved for incline angle equal to 45 degree.

### Example 1

Efficiency of CO2 desorption influenced type of anodized aluminum alloyed.

Several types of aluminum were anodized in oxalic acid with a concentration of 0.1 mol/L under fixed voltage at 36 V for 12 h. Anodized coatings were applied to 1xxx, 3xxx, and 6xxx series aluminum. The structures of these coatings were assessed by scanning electron microscopy (SEM), laser scanning microscopy (LSM), infrared spectroscopy, Raman spectroscopy and contact angle.

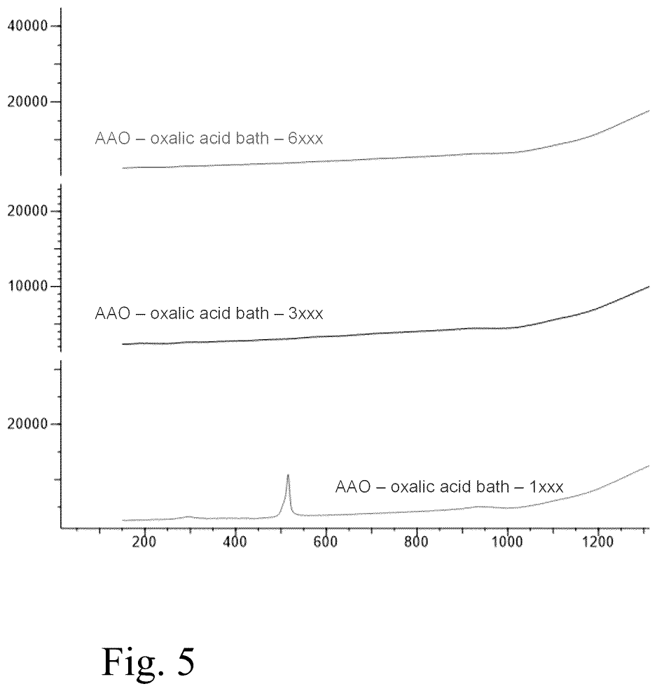

Analysis showed that the contact angle for water on anodized 1xxx was less than 5°, for the 3xxx was 18±5° and for the 6xxx was approximately 23±3°. Bare aluminum has a contact angle of 95±3°. As shown in FIG. 5, the surface obtained for anodized 1xxx aluminum type (lower spectrum) exhibited Raman bands at 530 cm⁻¹ and 321 cm⁻¹ that are not present in Raman spectra obtained for Anodized surface of 3xxx or 6xxx aluminum type. Due to relatively large background noise and fluorescence in wavenumber region from 1500 to 4000 cm⁻¹, the bands of the hydroxyl stretching region were not visible. In addition, the Raman band at 530 cm⁻¹ also has a shoulder band toward the lower wavenumber area (around 520 cm⁻¹). See Rodgers K. A. Clay minerals (1993) 28, 85-99. FTIR reveal other important characteristics including peaks associated with aluminum hydroxide esters near 1700 cm⁻¹.

The thickness of this functionalized aluminum hydroxide layer can be estimated from the z-dimension of the LSM results and furthermore by creating cross-sections for analysis by SEM. If we sandwich the subject material into epoxy, cut to reveal a cross-section, and polish—then we can analyze the cross-sectional structure by SEM. It will reveal that there are three layers—the Aluminum metal, the anodized aluminum (AL₂O₃) and a top rough layer that has functionalized aluminum hydroxide.

These surfaces were tested for their ability promote CO₂ desorption. An amine water solution saturated with CO₂ unexposed to anodized aluminum coupon was placed at Chittick Apparatus and initial amount present of CO₂ present in amine solution is measured. 50% MDEA aqueous solution was mainly carbonized by CO₂ bubbling for 5 hrs. The amine solution was then poured onto anodized aluminum.

The tested coupons with an area ranging between 4 sq.in (26 cm²) and 9 sq.in (58 cm²) were kept at isothermal conditions. The amine water solution was poured over anodized aluminum and the remaining of CO2 in solution is measured using Chittick technique. The coupon was mounted onto a flexible heater maintained at 80° C. and tilted at 45° impact angle. The CO₂ saturated amine fluid was poured from a height 1 inch above AAO with a fluid flowing steadily down a surface incline 45 (in degree) below the horizontal in anodized surface. The results are shown in the Table below.

| | | Presence of | | Thickness of |
|---|---|---|---|---|
| | CA | bands at | | Functional Layer, |
| AAO | (°) by | 1700 cm-1 | Efficiency | as determined |
| coupon | VCA | (FTIR) | (±SDDEV) | by LSM |
| Bare | 95 ± 3 | No | 15 ± 10 | not present |
| Aluminum | | | | |
| AAO-1xxx | <5 | Yes | 87 ± 5 | Rz = 25 um |
| AAO-3xxx | 18 ± 5 | Some minimal | 55 ± 15 | 10.1 um |
| | | presence | | |
| AAO-6xxx | 23 ± 3 | No | 30 ± 15 | Rz 3.9 um |

When fluid was passed onto AAO 1xxx surface, the anodized area promotes wicking and acceleration of the CO₂-laden fluid when it flows over the surface promote wicking and acceleration of the CO₂-laden fluid causing fast release of CO₂ with efficiency above 87%. This data shows that the presence of the anodized and functionalized layer improves CO₂ desorption by a factor of 5 (cf. table). On the other hand, when fluid was passed onto AAO 3xxx or 6xxx surface, the efficiency of CO2 desorption was found to be less than one obtained for AAO 1xxx. This data indicates that structures achieved with these anodization conditions for 3xxx and 6xxx are not as effective as 1xxx.

### Example 2

We hypothesized that tailoring the anodization rate using different anodization bath might accelerate the anodization process and various functionalization reactions, for 3xxx and 6xxx aluminum producing anodized alumina with CO2 desorption efficiency similar to the one observed in anodized 1xxx. Therefore, the next anodization process was obtained at mixture of H₂SO₄ (0.1 mol/L)—oxalic acid (0.1mol/l). Anodized alumina was prepared using 0.1 M mixture of sulfuric acid with oxalic with a molar ratio 1 to 1 at 30 V for 6 hrs. The anodized coating was applied to 6xxx aluminum series.

The measurements showed contact angle (CA) less than 5°. Ra (roughness) 2.7 μm, Rz 19.1 μm, and 78% efficiency.

The contact angle is the interior angle that a drop makes between the substrate and a tangent drawn at the intersection between the drop and the substrate. According to ASTM D5946 Standard, it was measured by capturing an image of the water drop sitting on the anodized Alumina surface and subsequently analyzing using Optical-Contact-Angle (OCA) system such as VCA Optima (AST Product Inc).

The changes of the surface were analyzed using 3D laser scanning microscope (LSM, Keyence Model VK-X260K). The sample was set on the XY stage of the measurement unit, and the 3D scan was performed. Initially the laser beam scans the target surface at certain Z-lens position and the laser intensity of the received reflection, as well as the height position of the lens, are recorded by the microscope. When the scan obtained of one surface finishes, the objective lens moves in the Z direction by the specified pitch. The similar surface scan is performed again for the surface and the reflected light intensity and lens height position are recorded in memory. 3D data were obtained for the observation area of the microscope by stitching together the lens height positions from the different times that the image was in focus.

Ra is the integer mean of all absolute roughness profile deviations from the centerline within the measurement length. Mean roughness value Ra (DIN 4768) is the arithmetic mean from all values of the roughness profile R within the measuring distance.

Rz is the absolute peak to valley average of five sequential sampling lengths within the measuring length (DIN 4768). The Average Depth of Roughness (Rz) is the arithmetic mean of the distance between global maximum and minimum in five successive single measuring section of the total evaluation length.

As shown by the analysis, we were able to achieve the target structure and the surfaces were effective at promoting CO2 desorption.

| | CA | | |
|---|---|---|---|
| | (°) by | Efficiency | |
| AAO coupon | VCA | (±SDDEV) | Roughness |
| Bare Aluminum | 95 ± 3 | 15 ± 10 | Ra Less 0.4 um |
| AAO-6xxx | Less than 5 | 78 ± 10 | Ra 2.7 um and Rz 19 um |

### Example 3

Anodized alumina was prepared using 0.1 M oxalic acid aqueous solution at 36 V for 14 hrs. The anodized coating was applied to 1xxx aluminum series. The anodized area was evaluated by 3D optical profilometer, electron microscopy, RAMAN spectroscopy and contact angle. The coupon was mounted onto flexible heater at kept at different isothermal conditions 40°, 80° C. and 100°. The coupon was tilted that the CO₂ saturated amine fluid poured from a height 1 inch above AAO flows steadily down a well-established surface incline 45° below the horizontal in anodized surface. When fluid was passing onto AAO 1xxx surface kept at 40° C., the anodized area promotes a CO2 desorption with efficiency around 45%. The desorption efficiency shows in drastically increase at 80° C., but it falls at 100° C. as summarized in the table below.

| AAO | Operating | Efficiency |
|---|---|---|
| coupon | Temperature | (±SDDEV) |
| 1xxx | 100° C. | 15 ± 10 |
| 1xxx | 80° C. | 87 ± 10 |
| 1xxx | 40° C. | 45 ± 10 |

### Example 4

Anodized alumina was prepared using 0.1 M oxalic acid aqueous solution at 36 V for 14 hrs. The anodized coating was applied to 1xxx aluminum series. The coupon was mounted onto a flexible heater and kept at 80° C. The CO₂ saturated of different amines were poured from a height 1 inch above AAO flows steadily down a well-established surface incline 45° below the horizontal in anodized surface.

When a primary amine such as 50% monoethanolamine (MEA) aqueous solution was passed onto AAO 1xxx surface kept at 80° C., the anodized area was unable to promote fast CO2 release. The desorption efficiency was less than 10%. On the other hand, when tertiary amine or primary with significant steric effect such as 50% MDEA or 50% AMP aqueous solution was passed onto AAO surface, the CO₂ desorption efficiency was 87% and 60%, respectively.

| | | | Surface |
|---|---|---|---|
| | Acro- | Efficiency | tension |
| Amine type | nym | (±SDDEV) | (mN · m⁻¹) |
| monoethanolamine | MEA | Less than 10 | 52 |
| Methyldiethanol amine | MDEA | 87 ± 10 | 54 |
| 2-amino-2-methyl-1-propanol | AMP | 50 ± 10 | 42 |

What is claimed:

1. A method of desorbing CO₂ from a CO₂-containing liquid solvent, comprising:
providing a liquid solution comprising CO₂ at a first temperature and first pressure;
wherein the liquid solution comprises at least 10 mass % of one or more amines;
contacting the liquid to a porous anodized aluminum surface or porous anodized titanium surface while increasing the temperature or reducing the pressure of the liquid solution; and
simultaneously or subsequently,
separating desorbed CO₂ gas from the liquid solution.

2. The method of claim 1 wherein the one or more amines comprise one or more amines selected from: secondary amines, tertiary amines, and hindered primary amines.

3. The method of claim 1 wherein the porous anodized aluminum surface or porous anodized titanium surface has a water contact angle of 12° or less, or 5° or less, or in the range of 1° to 10°.

4. The method of claim 1 wherein the porous anodized aluminum surface or porous anodized titanium surface has a pore structure such that at least 80 vol % of the pores are between 20 to 150 nm, or between 40 to 100 nm, or between 20 and 50 nm.

5. The method of claim 1 wherein the surface comprises cracks or microscale pathways.

6. The method of claim 1 wherein the porous anodized aluminum surface or porous anodized titanium surface has a thickness of at least about 10 μm into an aluminum or titanium substrate.

7. The method of claim 1 wherein the step of contacting occurs in a column with the porous anodized aluminum surface or porous anodized titanium surface is disposed over a plurality of plates.

8. The method of claim 1 wherein the porous anodized aluminum surface or porous anodized titanium surface is disposed on the surface of a packing material.

9. The method of claim 1 wherein the step of contacting the liquid to a porous anodized aluminum surface or porous anodized titanium surface occurs while increasing the temperature by at least 10° C., or at least 20° C., or at least 30° C. while the amine remains a liquid.

10. The method of claim 1 wherein the step of contacting occurs at an angle in the range of 30 to 60° or 40 to 50°.

11. The method of claim 1 wherein at least 30% or at least 50% or at least 70%, or in the range of 70 to 90% of CO₂ in the CO₂-containing liquid solvent is removed in the step of separating desorbed CO₂ gas from the liquid solution. 12. The method of claim 1 wherein the step of contacting the liquid comprises a jet of the liquid contacting the surface at a velocity of at least 10 m/s or at least 30 m/s or 25 to 200 m/s or 10 to 100 m/s.

13. The method of claim 1 wherein the contacting step is conducted at a temperature of 60 to 90 C and wherein at least 30% or at least 50% or at least 80% or 50 to about 90% of the CO₂ is desorbed.

14. A desorption composition comprising: an anodized aluminum substrate, coated with a porous alumina layer and a functionalized surface having an infrared absorption near 1712 cm⁻¹, and a Raman band near 530 cm⁻¹ when excited using 633 nm excitation.

15. The composition of claim 14 wherein the functionalized surface has a fluffy appearance when viewed under a microscope.

16. The composition of claim 14 having surface pores having a diameter in the range of 20-150 nm or 40-100 nm wherein these pores make up at least 80 vol % of the porosity.

17. The composition of claim 14 wherein the functionalized layer comprises a thickness in the range of 5 to 25 μm.

18. The composition of claim 14 wherein the functionalized surface comprises ester groups.

19. The composition of claim 14 wherein the functionalized surface comprises the reaction product of an aluminum hydroxide with a carboxylic acid; preferably oxalic acid.

20. The composition of claim 14 wherein the functionalized surface has a needle appearance when viewed under a scanning electron microscope.
